(19) United States
(12) Patent Application Publication
(10) Pub. No.: US 2026/0042346 A1
(43) Pub. Date: Feb. 12, 2026

(54) VEHICLE EMERGENCY EVENT DETECTION SYSTEM

(71) Applicant: Textron Inc., Providence, RI (US)

(72) Inventor: Shayne Evan Rimer, North Augusta, SC (US)

(73) Assignee: Textron Inc., Providence, RI (US)

(21) Appl. No.: 18/796,959

(22) Filed: Aug. 7, 2024

(51) Int. Cl. B60K 28/14; B60K 28/02; G06V 20/58; G07C 5/00; H04N 7/18

(52) U.S. Cl. CPC B60K 28/14; B60K 28/02; G07C 5/008; H04N 7/185; G06V 20/58

(57) ABSTRACT

A golf vehicle system includes a golf vehicle and a control system. The golf vehicle includes a chassis, a plurality of tractive assemblies coupled to the chassis, a prime mover configured to drive one or more of the plurality of tractive assemblies, and a sensor configured to monitor a surrounding environment of the golf vehicle at a golf course. The control system is configured to monitor the surrounding environment of the golf vehicle using data received from the sensor, detect an abnormal situation in the surrounding environment of the golf vehicle based on the data received from the sensor, and transmit an alert to a user device remote from the golf vehicle regarding the abnormal situation.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Various emergency situations may occur on the golf course. Such situations may not be promptly detected by others on the golf course, who may be directing their attention to a golf game or to another task on the golf course.

### SUMMARY

One embodiment relates to a golf vehicle system. The golf vehicle system includes a golf vehicle and a control system. The golf vehicle includes a chassis, a plurality of tractive assemblies coupled to the chassis, a prime mover configured to drive one or more of the plurality of tractive assemblies, and a sensor configured to monitor a surrounding environment of the golf vehicle at a golf course. The control system is configured to monitor the surrounding environment of the golf vehicle using data received from the sensor, detect an abnormal situation in the surrounding environment of the golf vehicle based on the data received from the sensor, and transmit an alert to a user device remote from the golf vehicle regarding the abnormal situation.

Another embodiment relates to a vehicle system. The vehicle system includes a non-transitory computer-readable medium having instructions stored thereon that, when executed by one or more processors, cause the one or more processors to acquire data from a sensor of a golf vehicle, monitor a surrounding environment of the golf vehicle on a golf course based on the data, detect an abnormal situation in the surrounding environment of the golf vehicle, and transmit an alert to a user device remote from the golf vehicle regarding the abnormal situation in the surrounding environment of the golf vehicle.

Still another embodiment relates to a method. The method includes acquiring data from a sensor of a golf vehicle, monitoring a surrounding environment of the golf vehicle on a golf course based on the data acquired from the sensor, detecting an abnormal situation in the surrounding environment of the golf vehicle, and transmitting an alert to a user device remote from the golf vehicle regarding the abnormal situation in the surrounding environment of the golf vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a side view of the vehicle of FIG. 1, according to an exemplary embodiment.

FIG. 5 is a perspective view of a golf course including the vehicle of FIG. 1 and a person in a distressed position, according to an exemplary embodiment.

FIG. 6 is a perspective view of a golf course including the vehicle of FIG. 1 and an overturned vehicle, according to an exemplary embodiment.

FIG. 7 is a perspective view of a golf course including the vehicle of FIG. 1 and a collision or accident, according to an exemplary embodiment.

FIG. 8 is a perspective view of a golf course including the vehicle of FIG. 1 and another vehicle in an improper location, according to an exemplary embodiment.

FIG. 9 is a perspective view of a golf course including the vehicle of FIG. 1 and of another vehicle being improperly used, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

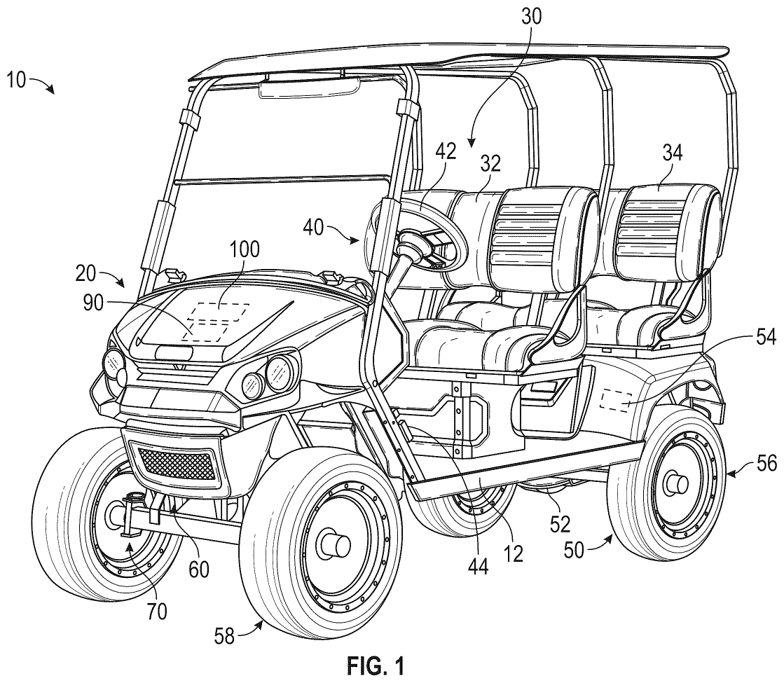

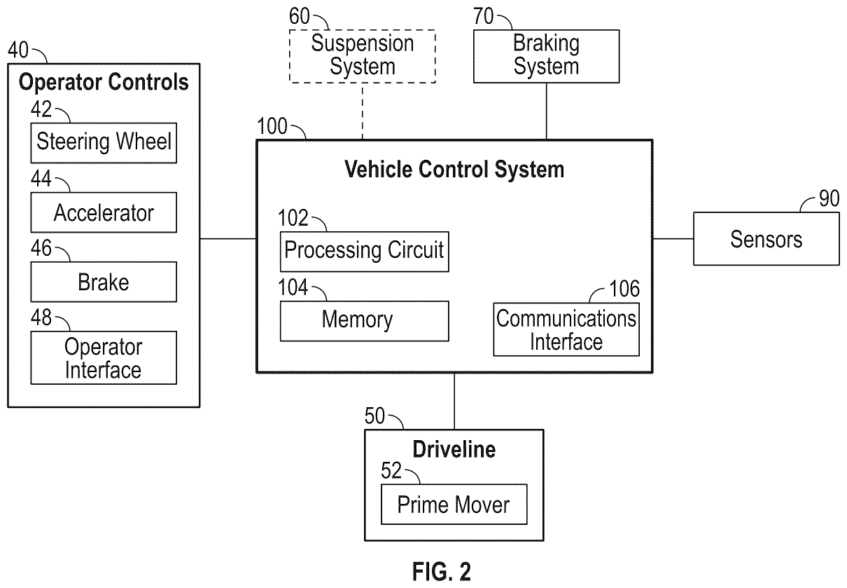

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

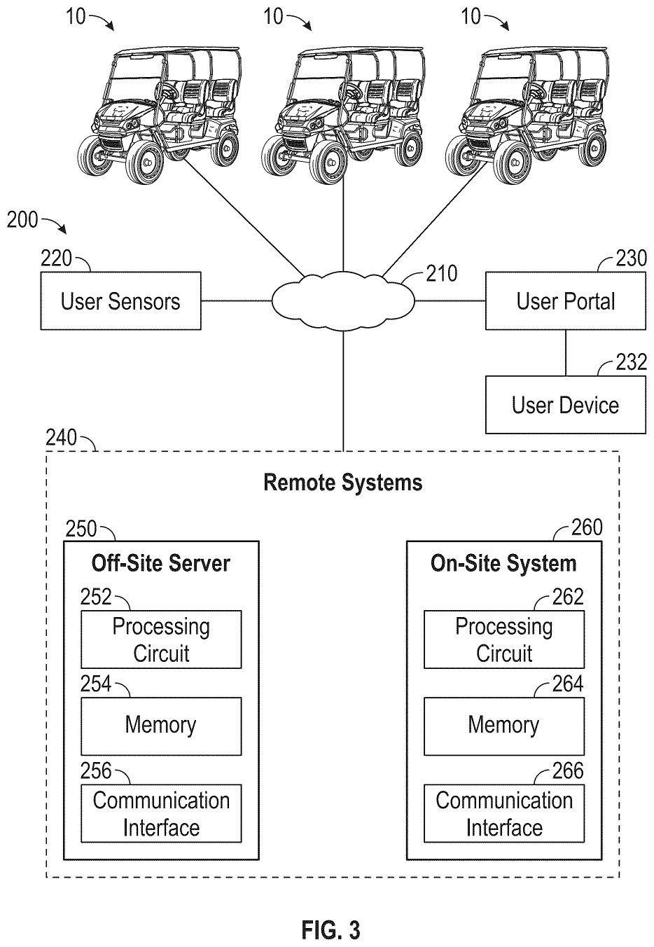

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Emergency Event Detection System

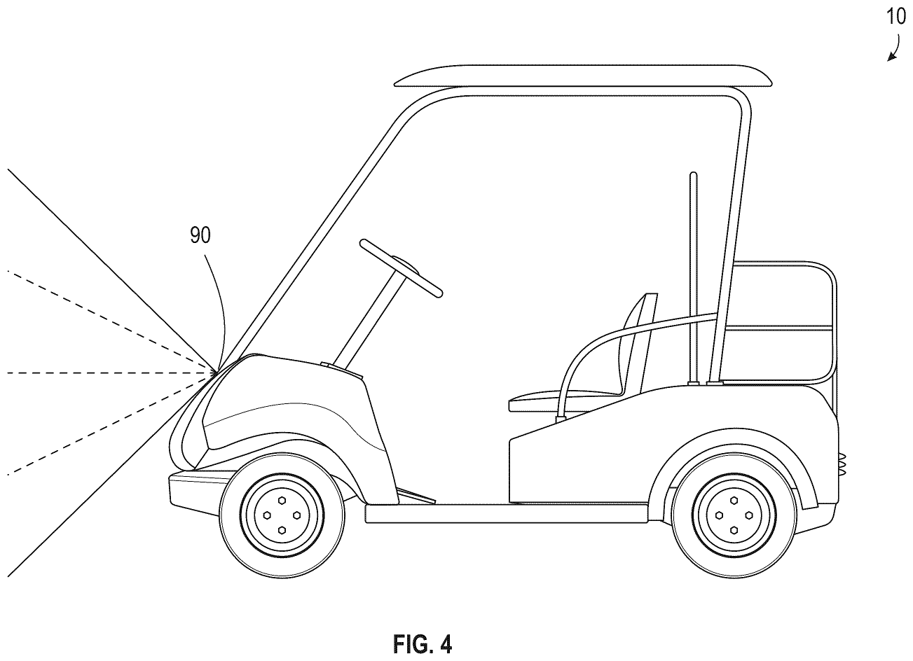

According to an exemplary embodiment, the vehicle control system 100 and the site monitoring and control system 200 are configured to facilitate detecting emergency and/or otherwise abnormal situations in a surrounding environment of the vehicle 10. As shown in FIGS. 4-9, the vehicle 10 is a golf cart or vehicle driven by an operator playing golf on a golf course 500. In some embodiments, the vehicle 10 is a drink cart, a cart driven by an employee of the golf course 500 monitoring the pace of play of golfers, a cart or vehicle driven by the maintenance crew working at the golf course 500, or another type of vehicle commonly found at golf courses (e.g., a turf mower, a sprayer, an aerator, a bunker rake, etc.). As described above, the vehicle 10 includes the sensors 90. According to an exemplary embodiment, the sensors 90 include a camera configured to facilitate monitoring a surrounding environment of the vehicle 10. In such embodiments where the vehicle 10 is a golf cart driven by an operator playing on the golf course 500, the surrounding environment refers to surrounding areas of the golf course 500 that may be in view of the camera.

Video and/or image data from the sensors 90 may be communicated to and processed by the vehicle control system 100 and/or the remote systems 240. In some embodiments, the video and/or image data is processed by an artificial intelligence model trained to identify abnormal situations within the data received from the sensors 90. The artificial intelligence model may be trained using a training dataset that includes normal training data (e.g., video and/or image data that depict normal situations on a golf course) and abnormal training data (e.g., video and/or image data that depict abnormal/emergency situations on a golf course). For example, as described herein, normal training data may include video and/or image data depicting a golf player taking a golf swing, one or two people sitting in a golf cart, a golf cart travelling along a cart path and/or a fairway, and so on. The abnormal training data, as described herein, may include a person (e.g., person 510) lying on the golf course, a person (e.g., person 510) hanging from a side of a golf cart, a golf cart located on a putting green (e.g., putting green 505), a golf cart in a collision with another golf cart and/or other object (e.g., tree 705), an overturned golf cart, and so on. Therefore, the artificial intelligence model may be configured to identify an abnormal situation on the golf course from the video and/or image data received from the sensors 90 based on the normal training data and the abnormal training data.

In some embodiments, responsive to identifying an abnormal situation from the video and/or image data received from the sensors 90, the vehicle control system 100 and/or the remote systems 240 are configured to alert the user portal 230 regarding the abnormal situation. For example, the alert may be received by a computer or a mobile device (e.g., the user device 232) in a golf shop located at the golf course 500. As another example, the alert may be received via an interface of each of a plurality of golf carts (e.g., vehicles 10) in operation on the golf course 500 at the time of the alert. In this way, other players on the golf course 500 may be notified that pace of play could be impacted by the abnormal situation, that a particular hole or location on the golf course 500 should be avoided such that the other players do not interfere with the abnormal situation, and so on. In some embodiments, the alert includes a location of the abnormal situation (e.g., a hole on the golf course), a severity of the abnormal situation, an identification of the vehicle 10 involved in the abnormal situation, an identification of the vehicle 10 capturing the abnormal situation using the sensors 90 coupled thereto, an option to disable operation of the vehicle 10 involved in the abnormal situation, etc.

Additionally or alternatively, the alert may include the video and/or image data received from the sensors 90. In some embodiments, the video and/or image data may include video recordings, still image photos, and/or a live feed of video data captured by the sensors 90. Where the alert includes the live feed of the video data, a user of the user device 232 that receives the alert (e.g., a golf shop attendant, a superintendent, a golf professional, a manager, etc.) may view the abnormal situation in real time as seen by the cameras on the vehicle 10. In this way, the user may determine the severity of the abnormal situation and can dismiss the alert if the situation is determined to be falsely detected as abnormal, if the abnormal situation resolves itself, if no further action is required in the situation, etc. In some embodiments, the alert may include an option to view the live feed.

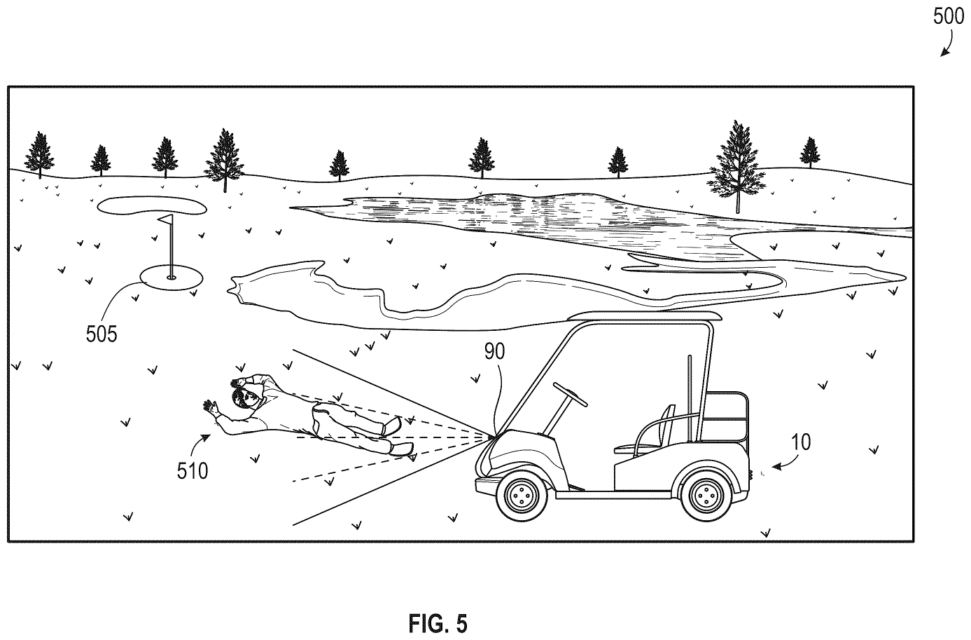

Referring to FIG. 5, the vehicle 10 is shown on the golf course 500. The golf course 500 includes the putting green 505 and the person 510. The person 510 is shown in the surrounding environment of the vehicle 10 in a distressed position. In this instance, the vehicle 10 (e.g., using the sensors 90 monitoring the surrounding environment of the vehicle 10) may identify the person 510 in the distressed position (e.g., lying on the golf course 500) as an abnormal situation. The distressed position may be identified using the artificial intelligence model trained using the normal and abnormal training data. As described above, the vehicle control system 100 and/or the remote systems 240 may transmit an alert to the user portal 230 regarding the abnormal situation. In this example, the alert may include an option to dispatch first responder support (e.g., paramedic support) if the distressed position indicates a medical emergency on the golf course 500.

The vehicle control system 100 and/or the remote systems 240 may additionally or alternatively be configured to disable movement of the vehicle 10 in response to detection of the abnormal situation. For example, if the abnormal situation includes a person in the distressed position, disabling movement of the vehicle 10 prevents any interference with the situation and/or first responders and keeps the sensors 90 in a position to continue providing feedback regarding the situation (e.g., video recording, images, a live video feed, etc.). In some embodiments, the movement of the vehicle 10 may be disabled until a user authorized to access the user portal 230 (e.g., a golf shop attendant, a superintendent, a golf professional, a manager, etc.) determines that the abnormal situation is resolved and allows the vehicle 10 to continue moving on the golf course 500.

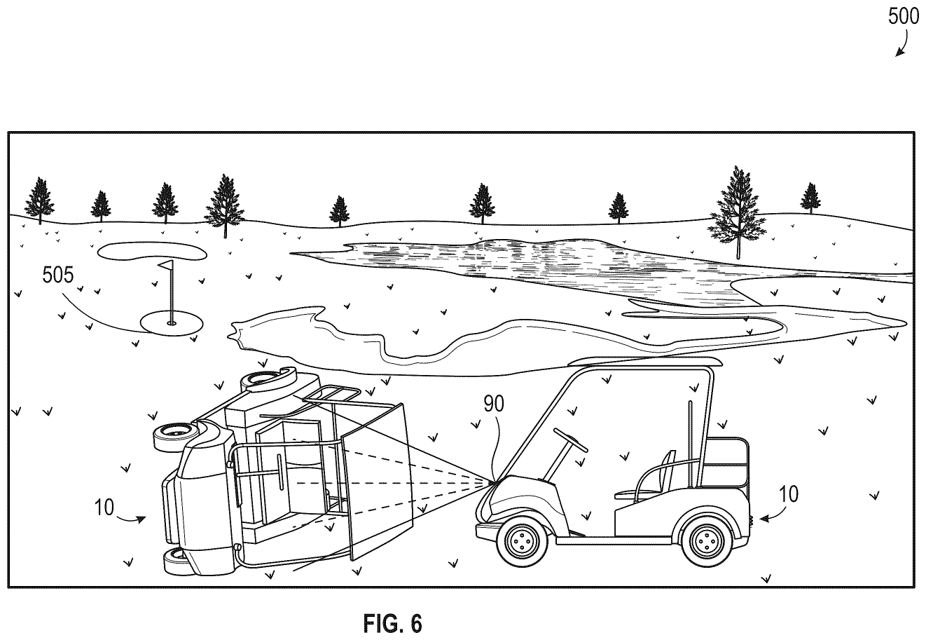

Referring to FIG. 6, an overturned vehicle is shown on the golf course 500 in the surrounding environment of the vehicle 10 while monitoring the surrounding environment using the sensors 90. For example, the overturned vehicle may include a vehicle 10 of the plurality of vehicles 10 depicted in FIG. 3. In this instance, the monitoring vehicle 10 may identify the overturned vehicle 10 as an abnormal situation. The overturned vehicle 10 may be identified using the artificial intelligence model trained on the normal and abnormal training data. For example, the normal training data may include a golf cart in an upright (e.g., “normal”) position. The upright position may, in some embodiments, be defined by the rear tractive elements and the front tractive elements being in contact with the ground of the golf course 500. Therefore, any identification of a golf cart in a position where at least one of the rear tractive elements or the front tractive elements is off the ground may be detected as an abnormal situation (e.g., an overturned vehicle).

As described above, the vehicle control system 100 and/or the remote systems 240 may transmit an alert to the user portal 230 regarding the abnormal situation. In response to the overturned vehicle 10, the alert may include a location of the overturned vehicle 10, such that appropriate personnel can go to the location of the overturned vehicle 10 and assist in returning the overturned vehicle 10 to an upright position. In some embodiments, the alert may include an option to disable operation of the overturned vehicle 10, such that the overturned vehicle remains stationary while in the overturned position. The alert may also include an option to resume the operation of the overturned vehicle 10 once the overturned vehicle 10 has returned to an upright position. For example, the personnel assisting in returning the overturned vehicle 10 to an upright position may authorize the operation of the overturned vehicle 10 once the situation is addressed. Additionally or alternatively, the remote systems 240 may receive an indication from the vehicle control system 100 (e.g., based on video and/or image data captured by the sensors 90) that the overturned vehicle 10 has returned to an upright position. In such embodiments, the remote systems 240 may automatically (e.g., without authorization from golf course personnel) allow the operation of the overturned vehicle 10 to resume in response to the indication from the vehicle control system 100 that the overturned vehicle 10 has returned to an upright position.

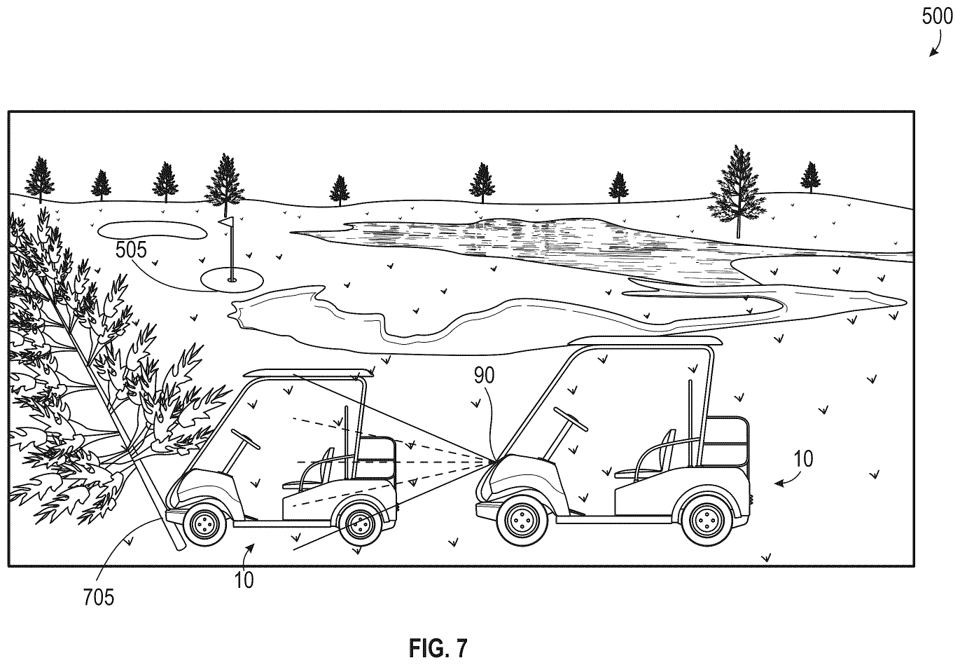

Referring to FIG. 7, the vehicle 10 is shown detecting, using the sensors 90, a collision in the surrounding environment of the vehicle 10 on the golf course 500. In this instance, the collision is shown to be between a golf cart (e.g., a vehicle 10 of the plurality of vehicles 10 shown in FIG. 3) and a tree 705. The vehicle 10 (e.g., using the sensors 90 monitoring the surrounding environment of the vehicle 10) may identify the collision as an abnormal situation. The collision may be identified using the artificial intelligence model trained on the normal and abnormal training data. Although the collision shown in FIG. 7 is between the vehicle 10 and the tree 705, the artificial intelligence model may be trained to detect a collision between multiple vehicles, between a vehicle and a building (e.g., a maintenance shed, a halfway house, a clubhouse, a cart barn, etc.), between a vehicle and a piece of equipment, etc. As described above, the vehicle control system 100 and/or the remote systems 240 may transmit an alert to the user portal 230 regarding the collision. In this example, the alert may include an option to notify maintenance staff and/or other relevant personnel of the collision such that any damages caused by the collision may be assessed and/or repaired. As described above with reference to FIG. 6, the alert may include an option to disable operation of the vehicle 10 involved in the collision until the abnormal situation is rectified.

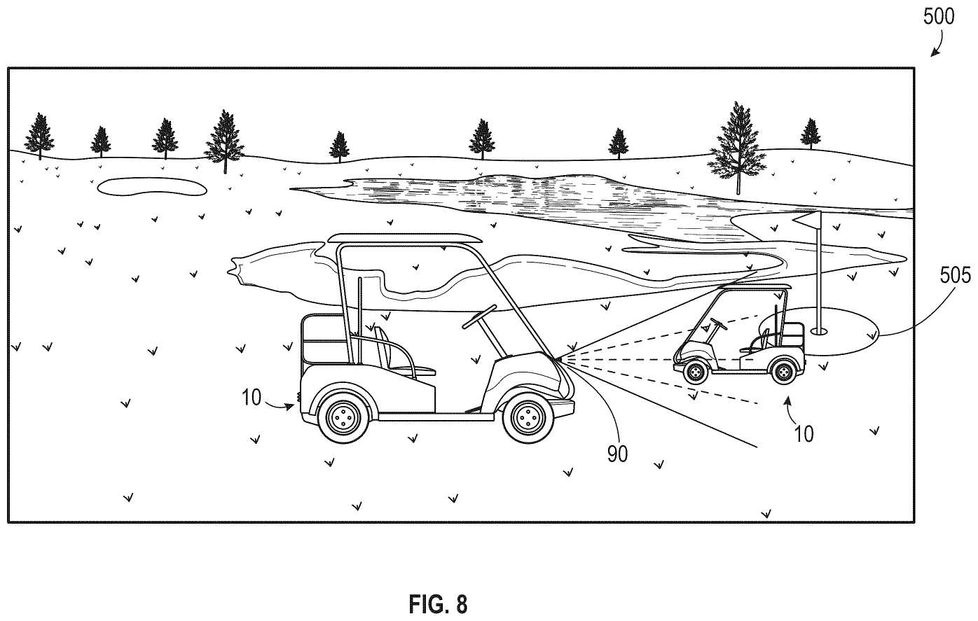

As shown in FIG. 8, the vehicle 10 is shown identifying, using the sensors 90, an improper location of a golf cart in the surrounding environment of the vehicle 10. In some instances, as depicted in FIG. 8, the vehicle may be a vehicle 10 of the plurality of vehicles 10 described above with reference to FIG. 3. The vehicle 10 may be configured to detect the improper location using the artificial intelligence model. In some embodiments, the normal training data may include various paths or locations where vehicles are allowed to travel on the golf course 500, and the abnormal training data may include other paths or locations where vehicles are not allowed to travel on the golf course 500. For example, the paths or locations where vehicles are allowed to travel may include a cart path, while the paths or locations where vehicles are not allowed to travel may include the putting green 505.

In certain embodiments, the paths or locations included in the normal training data and the paths included in the abnormal training data may vary depending on current cart path regulations. For example, on some occasions (e.g., when the golf course 500 is under wet conditions, after a rainfall, etc.), the vehicles 10 may not be allowed to travel on fairways (e.g., only on the cart path). During these occasions, fairways may be included in the abnormal training data. On other occasions, however, (e.g., when the golf course 500 is under dry conditions), the vehicles 10 may be allowed to travel on fairways and/or the cart path. During these other occasions, fairways may be included in the normal training data. Additionally or alternatively, the vehicles 10 may be allowed to travel along different paths according to a type of vehicle. For example, an aerator may be allowed on the putting green 505, a bunker rake may be allowed in a bunker, an all-terrain vehicle may be allowed in fescue, and so on. In the situation depicted in FIG. 8, the vehicle 10 detects a golf cart on the putting green 505, which is identified as an abnormal situation because a golf cart may not be allowed on the putting green 505, regardless of course conditions. If, however, FIG. 8 were to depict an aerator on the putting green 505, the vehicle 10 may not identify an abnormal situation in such an instance because an aerator may be allowed on the putting green 505.

As described above, the vehicle control system 100 and/or the remote systems 240 may transmit an alert to the user portal 230 regarding the improperly located vehicle 10. In response to the improperly located vehicle 10, the alert may include an option to transmit a warning to the improperly located vehicle 10 (e.g., via the operator interface 48). The warning may include a request for an operator of the improperly located vehicle 10 to move the vehicle 10 to a proper (e.g., allowed) location. In some embodiments, the warning may include directions to an allowed path, a map of allowed paths on which the vehicle 10 can travel, a reason why the vehicle 10 is not allowed in its current location, etc. In some instances, the warning may be transmitted automatically to the improperly located vehicle 10 upon detection of the abnormal situation. In such instances, the user portal 230 may receive an alert including a confirmation of the transmittal of the warning to the improperly located vehicle 10. Additionally or alternatively, the alert may include video and/or image data of the improperly located vehicle 10 captured by the sensors 90 of the monitoring vehicle 10, including, in some embodiments, a live feed of video data captured by the sensors 90.

In some embodiments, the alert includes an option to disable operation of the improperly located vehicle 10. In some embodiments, the improperly located vehicle 10 may be automatically disabled following a passage of time from when a warning message is sent to the improperly located vehicle 10. For example, after the improperly located vehicle 10 receives a warning message including a request to move to an allowed location, the improperly located vehicle 10 may have a predetermined amount of time (e.g., five minutes, ten minutes, etc.) to move the improperly located vehicle 10 to an allowed location. In this example, if the improperly located vehicle 10 fails to move to an allowed location, the user portal 230 may receive a second alert to notify relevant personnel (e.g., a golf shop attendant, a golf professional, etc.) that the improperly located vehicle 10 remains in an improper location. The relevant personnel may choose to travel to the location of the improperly located vehicle 10 and request that the operators of the improperly location vehicle 10 move the improperly located vehicle 10 to an allowed location or to remove the operators from the premises.

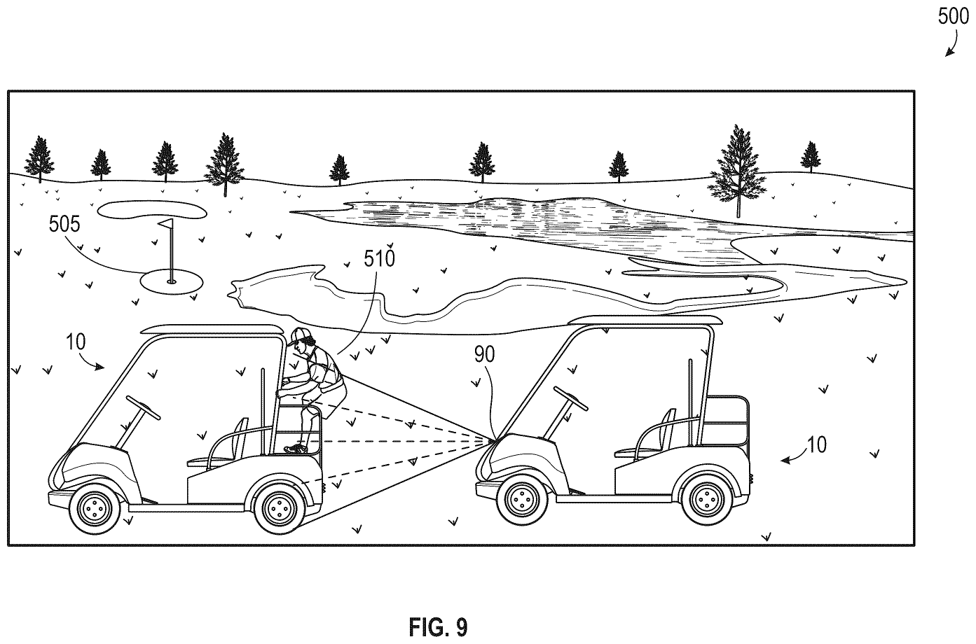

Referring to FIG. 9, the vehicle 10 is shown detecting, using the sensors 90, an improper usage of a golf cart (e.g., vehicle 10) in the surrounding environment of the vehicle 10 on the golf course 500. The improperly used vehicle may include a vehicle 10 of the plurality of vehicles 10 depicted in FIG. 3. As shown in FIG. 9, the improper usage of the vehicle 10 includes a person 510 hanging from a rear of the vehicle 10. In this instance, the monitoring vehicle 10 may identify the person 510 hanging from the rear of the vehicle 10 as an abnormal situation. The improper usage may be identified using the artificial intelligence model trained on the normal and abnormal training data. For example, the normal training data may include one or two players sitting in a golf cart, while the abnormal training data may include a surplus of people sitting in the vehicle 10 (e.g., more people than a designated number of seats), a person hanging off of the vehicle 10, an unauthorized user (e.g., a golf player) operating a maintenance vehicle (e.g., a mower, an aerator, etc.), and so on.

As described above, the vehicle control system 100 and/or the remote systems 240 may transmit an alert to the user portal 230 regarding the abnormal situation. In response to the improper usage of the vehicle 10, the alert may include an option to transmit a warning to the improperly used vehicle 10 (e.g., via the operator interface 48). In the situation depicted in FIG. 9, the warning may include a request for the person 510 to stop hanging off of the rear of the vehicle 10. In some embodiments, the warning may be transmitted automatically to the improperly used vehicle 10 upon detection of the abnormal situation. In such instances, the user portal 230 may receive an alert including a confirmation of the transmittal of the warning to the improperly used vehicle 10. Additionally or alternatively, the alert may include video and/or image data of the improper usage of the vehicle 10 captured by the sensors 90 of the monitoring vehicle 10, including, in some embodiments, a live feed of video data captured by the sensors 90.

In some embodiments, the alert includes an option to disable operation of the improperly used vehicle 10. The alert may also include an option to resume the operation of the improperly used vehicle 10 once the improperly used vehicle 10 has returned to its proper usage. According to certain embodiments, the remote systems 240 may receive an indication from the vehicle control system 100 (e.g., based on video and/or image data captured by the sensors 90) that the improperly used vehicle 10 has returned to its proper usage. In such embodiments, the remote systems 240 may automatically (e.g., without authorization from golf course personnel) allow the operation of the improperly used vehicle 10 to resume in response to the indication from the vehicle control system 100 that the improperly used vehicle 10 has returned to its proper usage.

Alternatively or additionally, the improperly used vehicle 10 may be automatically disabled following a passage of time from when a warning message is sent to the improperly used vehicle 10. For example, after the improperly used vehicle 10 receives a warning message regarding the improper usage, the improperly used vehicle 10 may have a predetermined amount of time (e.g., ten seconds, one minute, etc.) to return to its proper usage. In this example, if the improperly used vehicle 10 fails to return to its proper usage, the user portal 230 may receive a second alert to notify relevant personnel (e.g., a golf shop attendant, a golf professional, etc.) that the improperly used vehicle 10 remains improperly used. The relevant personnel may choose to travel to the location of the improperly used vehicle 10 and request that the operators of the improperly used vehicle 10 return the improperly used vehicle 10 to its proper usage or to remove the operators from the premises.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle system comprising:
a golf vehicle including:
a chassis;
a plurality of tractive assemblies coupled to the chassis;
a prime mover configured to drive one or more of the plurality of tractive assemblies; and
a sensor configured to monitor a surrounding environment of the golf vehicle at a golf course; and
a control system configured to:
monitor the surrounding environment of the golf vehicle using data received from the sensor;
detect an abnormal situation in the surrounding environment of the golf vehicle based on the data received from the sensor; and
transmit an alert to a user device remote from the golf vehicle regarding the abnormal situation.

2. The golf vehicle system of claim 1, wherein the abnormal situation includes at least one of an overturned vehicle, a person in a distressed position, a collision, an improper location of a parked vehicle, or an improper usage of a vehicle in the surrounding environment of the golf vehicle.

3. The golf vehicle system of claim 2, wherein the abnormal situation includes the person in the distressed position in the surrounding environment of the golf vehicle.

4. The golf vehicle system of claim 2, wherein the abnormal situation includes the collision in the surrounding environment of the golf vehicle.

5. The golf vehicle system of claim 2, wherein the abnormal situation includes the improper location of the parked vehicle in the surrounding environment of the golf vehicle.

6. The golf vehicle system of claim 2, wherein the abnormal situation includes the improper usage of the vehicle in the surrounding environment of the golf vehicle.

7. The golf vehicle system of claim 2, wherein the abnormal situation includes the overturned vehicle in the surrounding environment of the golf vehicle.

8. The golf vehicle system of claim 1, wherein the sensor includes a camera.

9. The golf vehicle system of claim 1, wherein the control system is a machine vision system that utilizes an artificial intelligence model to detect the abnormal situation in the surrounding environment.

10. The golf vehicle system of claim 1, wherein the golf vehicle further includes a global positioning system sensor configured to facilitate determining a location of the golf vehicle, wherein the alert includes the location of the golf vehicle.

11. The golf vehicle system of claim 1, wherein the control system is configured to:
disable movement of the golf vehicle in response to detecting the abnormal situation in the surrounding environment; and
provide a live video feed of the abnormal situation to the remote user device based on the data received from the sensor.

12. The golf vehicle system of claim 1, wherein the control system includes one or more processing circuits including at least one of (a) a first processing circuit located on the golf vehicle or (b) a second processing circuit located remote from the golf vehicle.

13. A vehicle system comprising:
a non-transitory computer-readable medium having instructions stored thereon that, when executed by one or more processors, cause the one or more processors to:
acquire data from a sensor of a golf vehicle;
monitor a surrounding environment of the golf vehicle on a golf course based on the data;
detect an abnormal situation in the surrounding environment of the golf vehicle; and
transmit an alert to a user device remote from the golf vehicle regarding the abnormal situation in the surrounding environment of the golf vehicle.

14. The vehicle system of claim 13, further comprising the golf vehicle including:
a chassis;
a plurality of tractive assemblies coupled to the chassis;
a prime mover configured to drive one or more of the plurality of tractive assemblies; and
the sensor;
wherein the golf vehicle is a golf-cart, an all-terrain vehicle, a utility task vehicle, a low speed vehicle, a lightweight or recreational vehicle, a mower, an aerator, a turf sprayer, or a bunker rake.

15. The vehicle system of claim 13, wherein the instructions, when executed by the one or more processors, cause the one or more processors to acquire a location of the golf vehicle, and wherein the alert includes the location of the golf vehicle.

16. The vehicle system of claim 13, wherein the abnormal situation includes at least one of an overturned vehicle, a person in a distressed position, a collision, an improper location of a parked vehicle, or an improper usage of a vehicle.

17. The vehicle system of claim 13, wherein the instructions, when executed by the one or more processors, cause the one or more processors to disable movement of the golf vehicle in response to detecting the abnormal situation in the surrounding environment of the golf vehicle.

18. The vehicle system of claim 13, wherein the instructions, when executed by the one or more processors, cause the one or more processors to provide a live feed of the abnormal situation in the surrounding environment of the golf vehicle to the user device.

19. The vehicle system of claim 13, wherein the instructions, when executed by the one or more processors, cause the one or more processors to utilizes an artificial intelligence model to detect the abnormal situation in the surrounding environment.

20. A method comprising:
acquiring data from a sensor of a golf vehicle;
monitoring a surrounding environment of the golf vehicle on a golf course based on the data acquired from the sensor;
detecting an abnormal situation in the surrounding environment of the golf vehicle; and
transmitting an alert to a user device remote from the golf vehicle regarding the abnormal situation in the surrounding environment of the golf vehicle.
